(19) United States
(12) Patent Application Publication
(10) Pub. No.: US 2009/0321610 A1
(43) Pub. Date: Dec. 31, 2009

(54) SUPPORTING MEMBER AND ELECTRONIC DEVICE INCLUDING THE SAME

(75) Inventors: Min Che Kao, Taipei (TW); Chun Wen Chen, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ASUSTek Computer Inc., Taipei (TW)

(21) Appl. No.: 12/433,538

(22) Filed: Apr. 30, 2009

(30) Foreign Application Priority Data
Jun. 27, 2008 (TW) 097124141

(51) Int. Cl. F16M 11/00

(52) U.S. Cl. 248/690

(57) ABSTRACT

The invention provides a supporting member and an electronic device including the same. The supporting member according to the invention may dispose an object on a target firmly. Furthermore, the supporting member includes a circular body and a plurality of bumps. The circular body has an outer surface and is sleeved on the object. Moreover, the bumps are formed on the outer surface, and the height of each bump is different from each other. Particularly, when the circular body is sleeved on the object and disposed on the target, some of the bumps contact the target.

### BACKGROUND OF THE INVENTION

1. Field of the Invention

The invention relates to a supporting member and an electronic device including the same. More particularly, the supporting member of the invention may dispose the electronic device on a slanted or uneven surface firmly.

2. Description of the Prior Art

With the development of the related electronic technology, electronic devices such as computers or mobile phones become necessary auxiliary tools in modern people's life. A user wishes to obtain information, communicate with others, finish works and enjoy entertainment via electronic devices anywhere and anytime. Thus, the user pays more attention to the portability when he or she chooses an electronic product.

Nowadays, there are many portable electronic devices having good portability which satisfy the user in the market. For example, a mobile phone may allow the user to communicate with others anywhere and anytime, a music player may allow the user to listen to the music anytime and anywhere, a palm computer may allow the user to finish works anytime and anywhere, and a satellite positioning system receiver may allow the user to know the current position.

In addition, the user may use the electronic devices in different kinds of condition. In a vehicle, the user may use a head-up display (HUD) to project information such as a vehicle speed to a windscreen. He may use a navigation device to plan the driving route to the destination or provide entertainment to the passengers with an audio and video player.

Generally, except for the electronic devices which have been integrated in the vehicle during manufacturing, the portable electronic devices used in vehicles are always disposed on an instrument panel or around a central console by supporting brackets or other members to provide different kinds of information to the user. In addition, the portable electronic devices also may be stuck to the instrument panel or around the central console by different kinds of glue.

To take the HUD as an example, it is usually disposed in front of the instrument panel, and the vehicle speed and other information are projected on the windscreen via the reflection of the windscreen. If the HUD is not designed by the original manufacturing factory, a projection plane of a light source usually needs to be adjusted to match the slanted angle of a front area of the instrument panel. Thus, the light source may be projected to a proper position of the windscreen.

As shown in FIG. 1A, it is a schematic diagram showing the disposition of the HUD in the prior art. As shown in FIG. 1A, the HUD 70 is disposed at the side area of the instrument panel 74 via the supporting bracket 72, and the image (such as the current speed) displayed by the HUD 70 is projected on the windscreen 76. As shown in FIG. 1B, it is a schematic diagram showing the disposition of the HUD in the prior art. As shown in FIG. 1B, the HUD 70 is disposed on the front block portion 79 of the vehicle via a Velcro 78, and the image (current time) displayed by the HUD 70 may be projected on the windscreen 76.

However, since the fastening mode using a supporting bracket needs many components, large space may be occupied. In addition, it is easy to be affected by outside force due to the shake of the vehicle. The portable electronic devices may shake and drop. The sticking mode is relatively firm, but the slanted angle and the position cannot be adjusted.

### SUMMARY OF THE INVENTION

Accordingly, the invention provides a supporting member for disposing an object on a target firmly. More particularly, the supporting member according to the invention is not only able to dispose the object on the target firmly, but also able to adjust the angle of the object according to different target surfaces (especially slanted or uneven surfaces).

According to an embodiment of the invention, the supporting member includes a circular body and a plurality of bumps. The circular body is sleeved on the object and has an outer surface. The bumps are formed on the outer surface, and the heights of the bumps are different from each other. In addition, when the circular body is sleeved on the object and disposed on the target, some of the bumps contact the target.

Another aspect of the invention provides an electronic device including the supporting member to solve the problem in the prior art.

According to an embodiment of the invention, the supporting member may dispose the electronic device on a target firmly. The supporting member includes a circular body and a plurality of bumps. The circular body is sleeved on a first end of the electronic device and has an outer surface. The bumps are formed on the outer surface, and the heights of the bumps are different from each other. In addition, when the circular body is sleeved on the electronic device and disposed on the target, some of the bumps contact the target.

In actual application, the electronic device of the invention may include a plurality of supporting members to be disposed on the target firmly, and thus the slanted angle of the electronic device may be adjusted more delicately.

These and other features, aspects and advantages of the present invention will become better understood with regard to the following description, appended claims, and accompanying drawings.

### BRIEF DESCRIPTION OF THE APPENDED DRAWINGS

FIG. 1A and FIG. 1B are schematic diagrams showing the disposition of the head-up displays in the prior art;

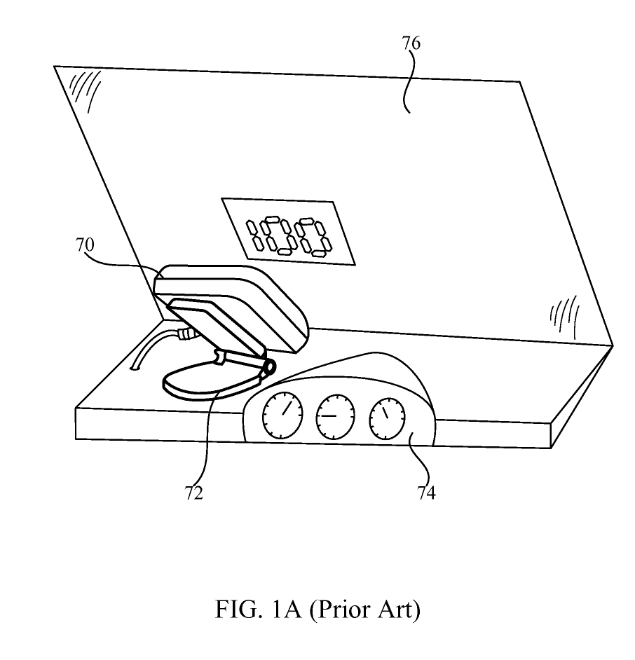

FIG. 2 is a schematic diagram showing the supporting member according to an embodiment of the invention;

FIG. 3 is a schematic diagram showing that the supporting member is sleeved on the object according to an embodiment of the invention;

FIG. 4A and FIG. 4B are side views showing that the supporting member is disposed on the target in FIG. 3;

FIG. 5 and FIG. 6 are side views showing the supporting member in an embodiment of the invention; and

FIG. 7 is a schematic diagram showing the electronic device according to an embodiment of the invention.

### DETAILED DESCRIPTION OF THE INVENTION

The invention provides a supporting member and an electronic device including the same. The supporting member of the invention may dispose an object on a target firmly.

In actual application, the object may be an electronic device such as a music player, an audio and video player, a satellite positioning receiver, a navigation device, a HUD, a communication device or other proper electronic devices. In actual application, the object also may be other objects in daily life, such as an accommodating box, various bottles, stationery and so on, and it is not limited thereto.

In addition, in application, the supporting member of the invention may firmly dispose the object on any proper target such as a tabletop, a vehicle windscreen or other object surfaces, and it is not limited thereto. Especially, the supporting member of the invention may dispose the object on the slanted, bent or other uneven surfaces of the target.

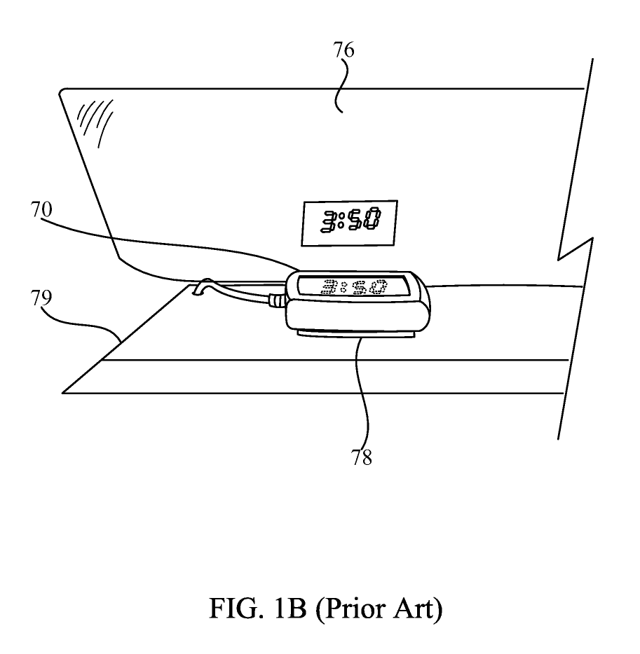

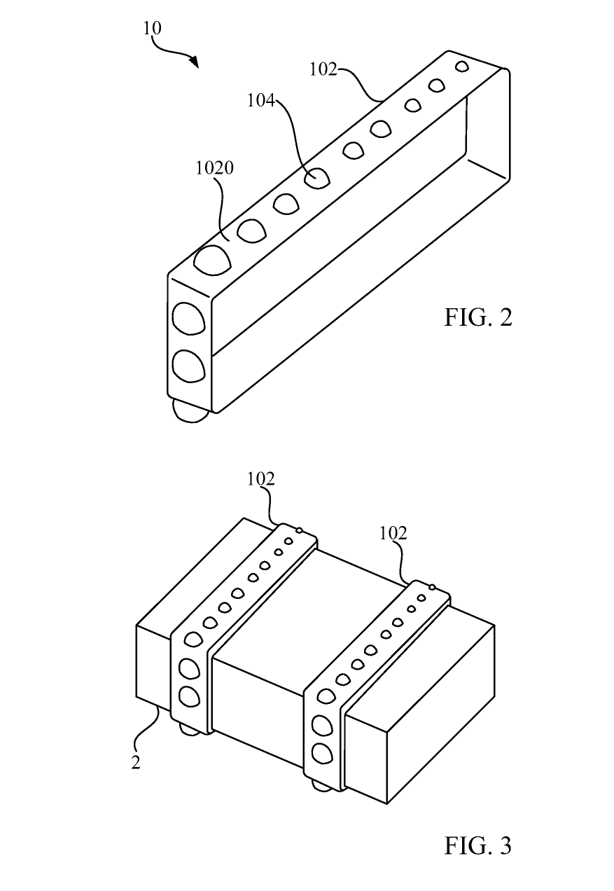

FIG. 2 is a schematic diagram showing the supporting member according to an embodiment of the invention. FIG. 3 is a schematic diagram showing that the supporting member is sleeved on an object according to an embodiment of the invention. As shown in FIG. 2 and FIG. 3, the supporting member 10 according to the invention includes a circular body 102 and a plurality of bumps 104. The circular body 102 has an outer surface 1020 and is sleeved on the object 2. The bumps 104 are formed on the outer surface 1020, and the heights of the bumps are different from each other.

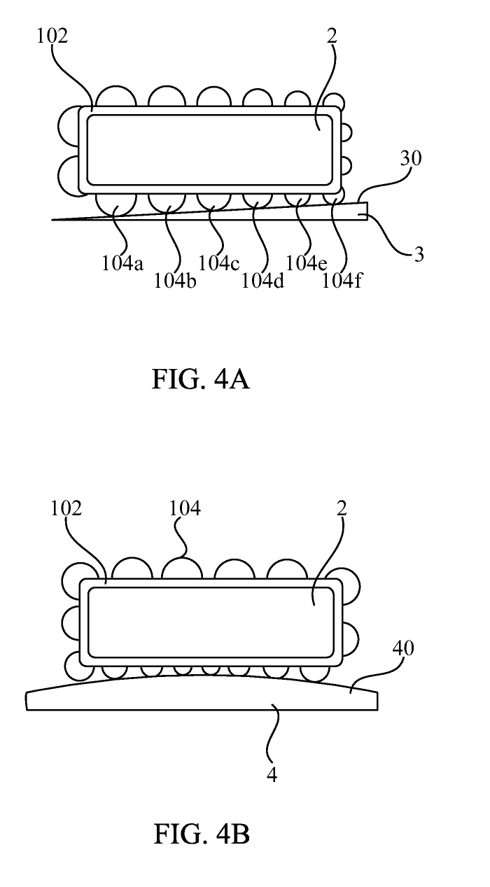

As shown in FIG. 4A and FIG. 4B, they are side views showing that the supporting member of the invention is disposed on the target. As shown in FIG. 4A, when the circular body 102 is sleeved on the object 2 and disposed on the target 3, some of the bumps 104a to 104f of the bumps 104 contact the target 3. In FIG. 4, the target 3 has a slanted surface 30, and since the bumps 104a to 104f have different heights, they can touch the slanted surface 30 of the target 3 closely after they are adjusted. Thus, the object 2 may keep horizontal.

As shown in FIG. 4B, when the target 4 has a raised surface 40, the user may rotate the circular body 102 to adjust the bumps which contact the raised surface 40 to keep the object 2 horizontal. If the user wants to incline the object, he or she may adjust the circular body 102 to make other bumps of the bumps contact the raised surface 40 of the target 4.

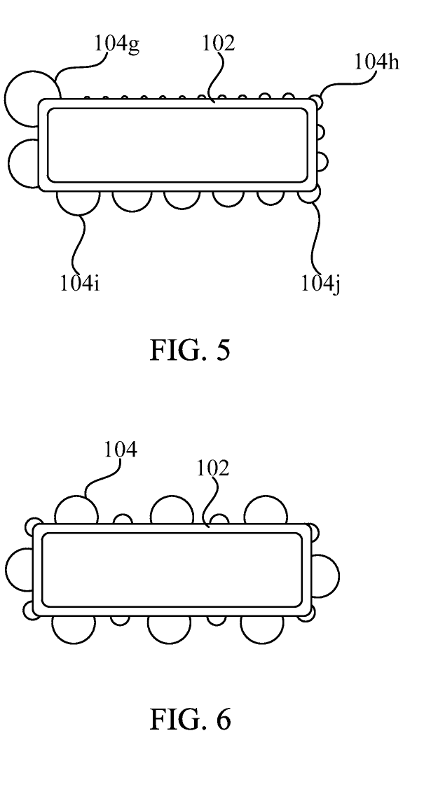

FIG. 5 is a side view showing the supporting member in an embodiment of the invention. As shown in FIG. 5, the bumps 104 are formed on the outer surface of the circular body 102 according to their heights from high to low (or from low to high). Thus, the slanted angle formed by the bumps 104g and 104h is big, and the slanted angle formed by other bumps (such as the bumps between bump 104i and bump 104j) is small. The slanted angle can be adjusted according to the requirement of the user.

As shown in FIG. 6, it is also a side view showing the supporting member in an embodiment of the invention. As shown in FIG. 6, the bumps 104 are formed on the outer surface alternately according to the heights. Thus, the supporting member may be used to dispose the object on the uneven surface.

In actual application, the arranging mode and the programming of the bumps may be adjusted according to the designer's or the user's requirement, and it is not limited thereto.

In actual application, the bumps may be formed on the circular body in a hot pressing molding mode, and the supporting member also may be manufactured in other proper processes or modes. In addition, in actual application, the bumps and the circular body are integrally formed.

In actual application, the bumps may be solid bumps or hollow bumps, and in actual application, the bumps are elastic, and they may buffer the pressure obtained by the object. In addition, the surfaces of the bumps are sticky, and thus the object is fixed to the target more firmly.

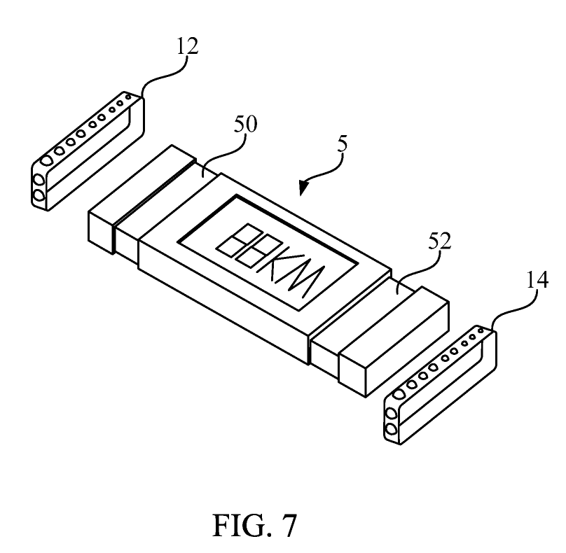

FIG. 7 is a schematic diagram showing the electronic device according to an embodiment of the invention. As shown in FIG. 7, the two ends of the electronic device has a first groove 50 and a second groove 52, and the two grooves are used to accommodate a first supporting member 12 and a second supporting member 14, respectively.

As shown in FIG. 7, the electronic device is a HUD. However, in actual application, the electronic device may be one of any other proper electronic devices, and they are not limited thereto. In addition, in the embodiment of the invention, the structure and feature of the supporting members 12 and 14 are the same to the above supporting member, and they are not illustrated again for concise purpose.

To sum up, the supporting member of the invention may dispose the object on the target firmly. Especially, when the targets have slanted or uneven surfaces, the supporting member of the invention may be adjusted to dispose the object on the surface firmly. In addition, since the bumps on the surface of the supporting member have different heights, the angle of the object also may be adjusted.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A supporting member used to dispose an object on a target firmly, the supporting member comprising:
a circular body having an outer surface and sleeved on the object; and
a plurality of bumps with different heights formed on the outer surface;
wherein when the circular body is sleeved on the object and disposed on the target, some of the bumps contact the target.

2. The supporting member according to claim 1, wherein the bumps are formed on the outer surface according to the heights from high to low sequentially.

3. The supporting member according to claim 1, wherein the bumps are formed on the outer surface alternately according to the heights.

4. The supporting member according to claim 1, wherein the bumps are formed on the circular body in a hot pressing molding mode.

5. The supporting member according to claim 1, wherein the bumps and the circular body are integrally formed.

6. The supporting member according to claim 1, wherein the bumps are solid bumps or hollow bumps.

7. The supporting member according to claim 1, wherein the bumps are elastic.

8. The supporting member according to claim 1, wherein the surfaces of the bumps are sticky.

9. The supporting member according to claim 1, wherein the object is an electronic device.

10. The supporting member according to claim 9, wherein the electronic device is selected from the group consisting of a music player, an audio and video player, a satellite positioning receiver, a navigation device and a head-up display (HUD).

11. An electronic device comprising:
a first supporting member used for disposing the electronic device on a target firmly, the first supporting member including:
a first circular body sleeved on a first end of the electronic device, wherein the first circular body has a first outer surface; and
a plurality of first bumps formed on the first outer surface, wherein the heights of the first bumps are different from each other, and some of the first bumps contact the target.

12. The electronic device according to claim 11, wherein the first end of the electronic device has a first groove for accommodating the first supporting member.

13. The electronic device according to claim 11, further comprising:
a second supporting member used to dispose the electronic device on the target firmly, the second supporting member including:
a second circular body sleeved on a second end of the electronic device opposite to the first end, wherein the second circular body has a second outer surface; and
a plurality of second bumps formed on the second surface, wherein the heights of the second bumps are different from the each other, and some of the second bumps contact the target.

14. The electronic device according to claim 13, wherein the second end of the electronic device has a second groove for accommodating the second supporting member.

15. The electronic device according to claim 11, wherein the first bumps are formed on the outer surface according to the heights from high to low sequentially.

16. The electronic device according to claim 11, wherein the first bumps are alternately formed on the outer surface according to the heights.

17. The electronic device according to claim 11, wherein the first bumps are formed on the first circular body in a hot pressing molding mode.

18. The electronic device according to claim 11, wherein the first bumps and the first circular body are integrally formed.

19. The electronic device according to claim 11, wherein the first bumps are solid bumps or hollow bumps.

20. The electronic device according to claim 11, wherein the first bumps are elastic.

21. The electronic device according to claim 11, wherein the surfaces of the first bumps are sticky.
